(19) United States
(12) Patent Application Publication
(10) Pub. No.: US 2002/0152670 A1
(43) Pub. Date: Oct. 24, 2002

(54) Floating bait harness

(76) Inventor: Paul Oleksak, Thunder Bay (CA)

Correspondence Address: ADE & COMPANY, 1700-360 MAIN STREET, WINNIPEG, MB, R3C3Z3, CA

(21) Appl. No.: 09/836,444

(22) Filed: Apr. 18, 2001

(51) Int. Cl. A01K 91/00

(52) U.S. Cl. 43/42.74

(57) ABSTRACT

A floating bait harness for use in fishing has a substantially T-shaped main body, a weighted bottom end on the main body arranged to engage a ground surface in a body of water and a top end on the main body arranged to be coupled to a line extending from a fishing rod, the top end is arranged to be positioned in a raised relationship relative to the weighted end such that the main body rests upright in the water. At least one hook arrangement extending from at least one side of the main body; the hook arrangement is arranged to support a hook such that the hook is raised a sufficient distance from the ground surface positioning the hooks in a feeding area of the fish. The harness also includes a balancing arrangement on the harness arranged to maintain the desired position of the harness.

### FIELD OF THE INVENTION

The present invention relates to a bait harness, more particularly the bait harness is arranged to raise the bait above the ground.

### BACKGROUND

As commonly known in fishing there is a great desire to be able to place a persons hook at the bottom of the lake or the like such that the baited hook is positioned slightly above the bottom within the feeding area of the fish. Some examples of known apparatus of this type are disclosed in U.S. Pat. No. 5,887,381 (Stephenson), U.S. Pat. No. 3,735,523 (Merrill), U.S. Pat. No. 4,750,289 (Rossa), U.S. Pat. No. 4,528,771 (Rea, Jr.), U.S. Pat. No. 5,661,923 (Fellowes), U.S. Pat. No. 4,450,645 (Ancona), U.S. Pat. No. 4,538,374 (Louthan), U.S. Pat. No. 4,888,911 (Pritchard), U.S. Pat. No. 4,428,144 (Dickinson), U.S. Pat. No. 4,019,275 (Ruppe) and U.S. Pat. No. 5,555,669 (Fitzgerald). The above mentioned Patents are baits which are arranged to be pulled behind a trolling boat or the like such that the bait is located in an area of feeding for fish while being trolled behind the boat.

### SUMMARY

According to one embodiment of the present invention there is provided a floating bait harness comprising;

at least one weighted leg which has a weighted end such that the weighted end engages a bottom surface of a body of water;

more than one extension arm extending generally at a right angle outwardly from a substantially top end of the weighted arm;

a line extending from the top end of the weighted arm to a fishing rod or the like above a surface of the body of water;

at least one leader at an outer end of each of the extension arms which is arranged to hang downwards therefrom, the leaders being shorter in length than the at least one weighted arm;

and at least one hook at the bottom end of each leader such that the hooks are a sufficient distance from the bottom surface of the body of water thereby being in an area in which a fish will be feeding.

According to alternative embodiment of the present invention there is provided a floating bait harness comprising:

a main body;

a weighted bottom end on the main body arranged to engage a ground surface in a body of water;

a top end on the main body arranged to be coupled to a line extending from a fishing rod, the top end is arranged to be positioned in a raised relationship relative to the weighted end such that the main body rests upright in the water;

at least one hook arrangement extending from at least one side of the main body; the hook arrangement is arranged to support a hook such that the hook is raised a sufficient distance from the ground surface positioning the hooks in a feeding area of the fish, and;

a balancing arrangement on the harness arranged to maintain the desired position of the harness.

Preferably the hook arrangement comprises a pair of outwardly extending arms which are coupled to the top end of the main body and extend in generally opposed directions.

Preferably the balancing arrangement has a floating device which provides sufficient floatation so that the main body is positioned upright and allows the weighted end to maintain contact with the ground surface.

Conveniently the balancing arrangement has floating devices which are coupled to an end of each arm which provides sufficient floatation so that the main body is positioned upright and allows the weighted end to maintain contact with the ground surface.

Preferably the harness is substantially T-shaped.

Conveniently a snap swivel is coupled to the top end of the main body arranged to connect the harness to a fishing line such that the harness is able to move freely without affecting the line.

### BRIEF DESCRIPTION OF THE DRAWINGS

In the accompanying drawings, which illustrate an exemplary embodiment of the present invention:

FIG. 1 is a side elevational view of the present invention.

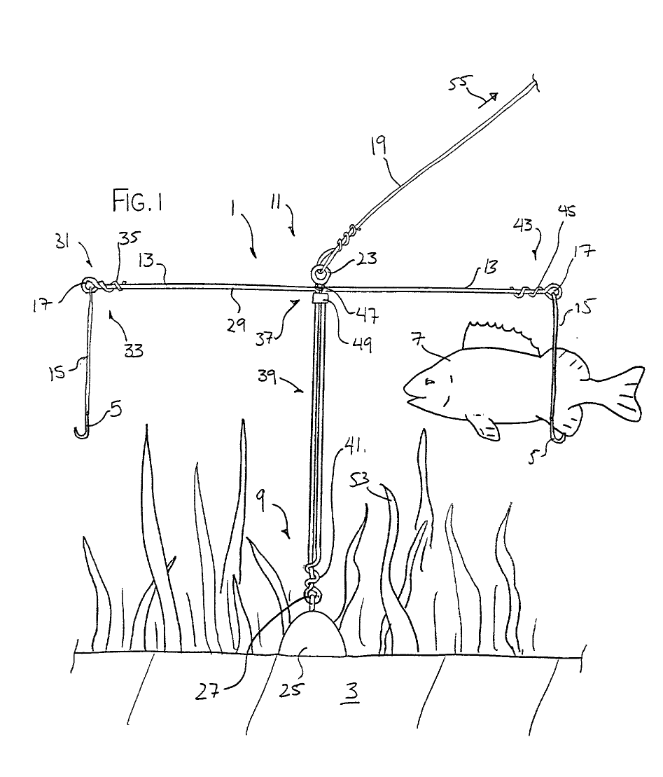

FIG. 2 is schematic illustration of the present invention showing a boat and rod.

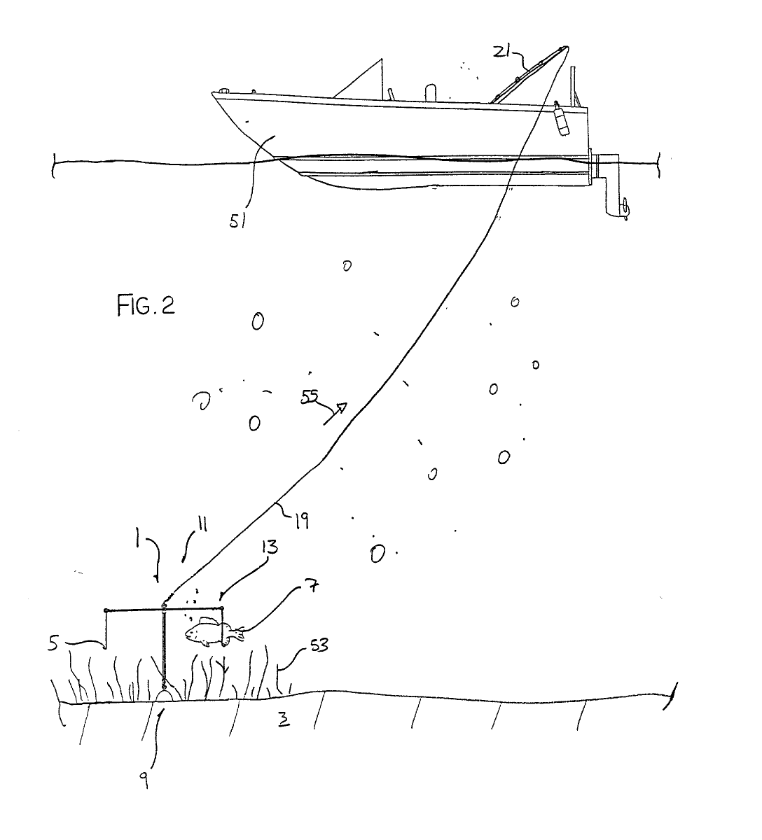

FIG. 3 is a side elevational view of a second embodiment of the present invention.

### DETAILED DESCRIPTION

Referring to the accompanying drawings, there is illustrated a floating bait harness 1 which is arranged to rest on a lake or body of water bottom 3 such that a pair of hooks 5 which bait or the like are suspended of the bottom such that the hooks are in the area in which a fish 7 is feeding. The floating bait harness has a weighted end 9, a floating end 11 and leader arms 13 extending outward from respective sides of the floating end. The hooks are located at each end of the leader arms and hang downward therefrom on the end of a leader 15. The leaders are connected to each end of the leader arms respectively at a leader loop 17. A line 19, extending to a rod 21, is connected to a line loop 23 which is located at an intersection 37 of the leader arms. At the weighted end there is a weight 25 which is arranged to engage the bottom and is connected to the floating bait harness by a weight loop 27 which is located directly below the line loop.

The floating bait harness is constructed of a single wire or rod 29 which is formed to substantially T-shape. The T-shape has a first end 31 which is defined by a first leader end 33. The first leader end is has a leader ring, mentioned above, which is formed by the wire by forming a twist 35 such that the wire is twisted about itself thereby forming a leader loop, as mentioned above. The wire then extends horizontally inwards, defining a leader arm, as mentioned above, to the line loop at the intersection of the leader arms wherein the wire extends downwards at a right angle thereto to the weighted end, defining weight arms 39. At the end of the weight arms the wire is bent to form the weight loop and a second twist 41 is formed by twisting the wire about itself and then extends upwardly parallel to the downwards extension of the wire. The wire extends upwards to the intersection and is bent at a right angle to the weight arm and extends horizontally outwards away from the first end to a second end 43, thereby defining the second leader arm, as mentioned above. At the second end the wire there is a third twist 45 wherein the wire is twisted about itself forming the second leader loop, as mentioned above, in which a leader is connected thereto. The leader arms are shorter in length than the weight arms such that the harness has sufficient balance, as well the leaders are approximately half the length of the weight arms such that the hooks remain a sufficient height from the ground.

At the intersection the wire has a fourth twist 47 wherein the line loop is located, as mentioned above. Directly below the line loop on the weight arms is a sleeve 49 which is located about the two arms such that the arms are fastened together holding the leaders arms at right angles to the weight arms. The sleeve is made of a material that floats such that the floating bait harness floats at the floating end. A buoyant material can be coupled at the intersection for added buoyancy.

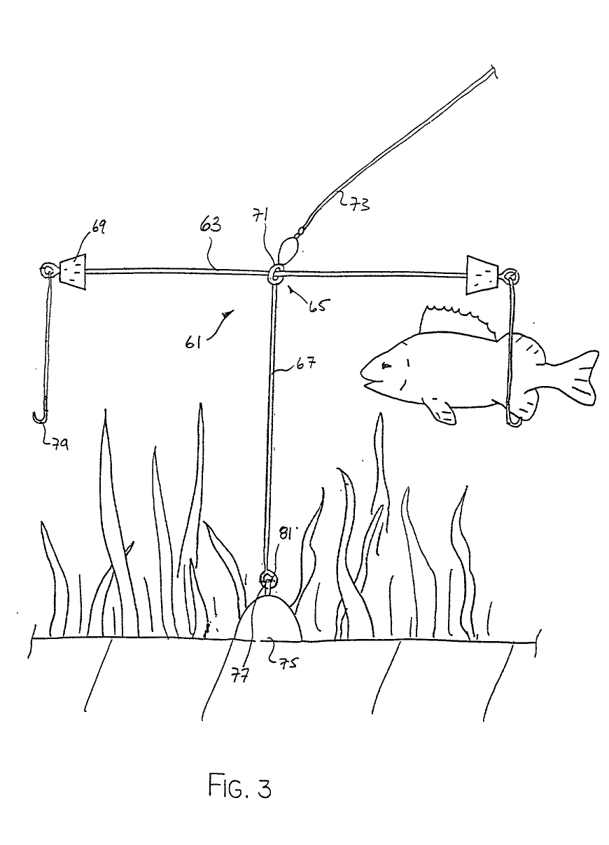

FIG. 3 shows a second preferred embodiment of the present invention. The second embodiment of the floating bait harness 61 has the same T-shaped arrangement as the first embodiment. The second embodiment has leader arms 63 extending generally horizontally outwards from a top end 65 of a main body 67. At outer ends of the leader arms is a floating device 69 which are arranged to provide floatation to the leader arms. The floating device as illustrated is a tapered cork but can be any sufficient floating material.

The leader arms are coupled to the top end of the main body by a snap swivel 71 which allow the arms to rotate about the main body for movement with the current within the water. The snap swivel also provides rotation at the point of connection to the line 73 such that the harness can rotate freely without twisting the line.

The main body is an elongate wire which is arranged to be positioned vertically in the water. Vertical positioning of the main body is provided by a weight 75 which is coupled to a bottom end 77 of the main body. The weight is arranged to engage the ground surface of the body of water such that the harness rests on the bottom. The main body extends vertically therefrom and is supported vertically by the floating device on the leader arms. Hooks 79 are coupled to ends of the leader arms and hang downwards such that the hooks are located in an area wherein the desired fish are feeding as well as being raised above the plant life such that the hooks do not get snagged by the plants.

The bottom end 77 of the main body has a weight 75 coupled thereto. The weight is arranged to engage the bottom and is connected to the floating bait harness by a weight loop 81 which is located directly below the swivel.

In operation, the floating bait harness is cast from a boat 51 or the like by the rod, as mentioned above, in to the water. The harness then submerges into the water and continues to sink until the weight engages the ground. The leader arms are arranged such that they float. The floatation of the arms allows the hooks at the end of the leaders to remain above the ground and plant life 53 such that the hooks are in the area where the fish is feeding. The line extends to the surface, indicated at arrow 55, and has sufficient slack so that the weight engages the ground.

While the embodiments of the present invention have been described in the foregoing, it is to be understood that other embodiments are possible within the scope of the invention. The invention is to be considered limited solely by the scope of the appended claims.

1. A floating bait harness comprising;
at least one weighted leg which has a weighted end such that the weighted end engages a bottom surface of a body of water;
more than one extension arm extending generally at a right angle outwardly from a substantially top end of the weighted arm;
a line extending from the top end of the weighted arm to a fishing rod or the like above a surface of the body of water;
at least one leader at an outer end of each of the extension arms which is arranged to hang downwards therefrom, the leaders being shorter in length than the at least one weighted arm;
and at least one hook at the bottom end of each leader such that the hooks are a sufficient distance from the bottom surface of the body of water thereby being in an area in which a fish will be feeding.

2. A floating bait harness comprises:
a main body;
a weighted bottom end on the main body arranged to engage a ground surface in a body of water;
a top end on the main body arranged to be coupled to a line extending from a fishing rod, the top end is arranged to be positioned in a raised relationship relative to the weighted end such that the main body rests upright in the water;
at least one hook arrangement extending from at least one side of the main body; the hook arrangement is arranged to support a hook such that the hook is raised a sufficient distance from the ground surface positioning the hooks in a feeding area of the fish, and;
a balancing arrangement on the harness arranged to maintain the desired position of the harness.

3. The harness according to claim 2 wherein hook arrangement comprises a pair of outwardly extending arms which are coupled to the top end of the main body and extend in generally opposed directions.

4. The harness according to claim 2 wherein the balancing arrangement has a floating device which provides sufficient floatation so that the main body is positioned upright and allows the weighted end to maintain contact with the ground surface.

5. The harness according to claim 3 wherein the balancing arrangement has floating devices which are coupled to an end of each arm which provides sufficient floatation so that the main body is positioned upright and allows the weighted end to maintain contact with the ground surface.

6. The harness according to claim 3 wherein the harness is substantially T-shaped.

7. The harness according to claim 2 wherein a snap swivel is coupled to the top end of the main body arranged to connect the harness to a fishing line such that the harness is able to move freely without affecting the line.
